(19) United States
(12) Patent Application Publication
(10) Pub. No.: US 2025/0007410 A1
(43) Pub. Date: Jan. 2, 2025

(54) SWITCHING CONVERTER COMMON MODE TRANSIENT IMMUNITY

(71) Applicant: TEXAS INSTRUMENTS INCORPORATED, Dallas, TX (US)

(72) Inventor: Youhao XI, Phoenix, AZ (US)

(21) Appl. No.: 18/675,552

(22) Filed: May 28, 2024

Related U.S. Application Data
(60) Provisional application No. 63/524,163, filed on Jun. 29, 2023.

(51) Int. Cl. H02M 3/335; B60L 50/51

(52) U.S. Cl. CPC H02M 3/33523; B60L 50/51; B60L 2210/10; B60L 2210/40

(57) ABSTRACT

A circuit includes a flyback switching circuit, a transformer, and a bypass network. The flyback switching circuit has a terminal configured to receive a power supply voltage, an output, and an input. The transformer includes a primary coil having a first terminal coupled to the terminal of the flyback switching circuit, and a second terminal coupled to the output of the flyback switching circuit. The bypass network has a first terminal coupled to the output of the flyback switching circuit, a second terminal coupled to the terminal of the flyback switching circuit, and a third terminal coupled to the input of the flyback switching circuit.

### CROSS-REFERENCE TO RELATED APPLICATIONS

This application claims priority to U.S. Provisional Application No. 63/524,163, filed Jun. 29, 2023, entitled “CMTI Mitigation for PSR Flyback Converters”, which is hereby incorporated by reference.

### BACKGROUND

A DC-DC converter is an electronic circuit that converts an input direct current (DC) voltage into one or more DC output voltages that are higher or lower in magnitude than the input DC voltage. A DC-DC converter that generates an output voltage lower than the input voltage is termed a buck or step-down converter. A DC-DC converter that generates an output voltage higher than the input voltage is termed a boost or step-up converter. A DC-DC converter that generates an output that is either higher or lower than the input voltage is termed a buck-boost converter.

Some DC-DC converter topologies include a drive/power switch coupled at a switch node to an inductor. Electrical energy is transferred through the inductor to a load by alternately opening and closing the switch as a function of a switching signal. The amount of electrical energy transferred to the load is a function of the ON/OFF duty cycle of the switch and the frequency of the switching signal.

A flyback converter is a type of switching converter that is based on the buck-boost converter, and includes a transformer in place of the inductor. The transformer includes a primary winding and a secondary winding across which voltage ratios are scaled. The transformer also provides galvanic isolation between the input and corresponding outputs. The flyback converter controls transistors and/or switches to charge and/or discharge inductors and/or capacitors to maintain a desired output voltage.

### SUMMARY

In one example, a circuit includes a flyback switching circuit, a transformer, and a bypass network. The flyback switching circuit has a terminal configured to receive a power supply voltage, an output, and an input. The transformer includes a primary coil having a first terminal coupled to the terminal of the flyback switching circuit, and a second terminal coupled to the output of the flyback switching circuit. The bypass network has a first terminal coupled to the output of the flyback switching circuit, a second terminal coupled to the terminal of the flyback switching circuit, and a third terminal coupled to the input of the flyback switching circuit.

In another example, a circuit includes a flyback switching circuit, a transformer, and a bypass network. The flyback switching circuit has a terminal configured to receive a power supply voltage, an output, and an input configured to receive a feedback signal. The transformer includes a primary coil and a secondary coil, the primary coil having a first terminal coupled to the terminal of the flyback switching circuit, and a second terminal coupled to the output of the flyback switching circuit. The bypass network has a first terminal coupled to the output of the flyback switching circuit, a second terminal coupled to the terminal of the flyback switching circuit, and a third terminal coupled to the input of the flyback switching circuit. The bypass network is configured to attenuate, at the input of the flyback switching circuit, transients passing from the secondary coil to the primary coil.

In a further example, a vehicle drive system includes an electric motor, an inverter circuit, and a flyback converter. The inverter circuit has an output coupled to the electric motor, and an input. The flyback converter includes a flyback switching circuit, a transformer, and a bypass network. The flyback switching circuit has a terminal configured to receive a power supply voltage, an output, and an input. The transformer includes a primary coil and a secondary coil. The primary coil has a first terminal coupled to the terminal of the flyback switching circuit, and a second terminal coupled to the output of the flyback switching circuit. The secondary coil is coupled to the input of the inverter circuit. The bypass network has a first terminal coupled to the output of the flyback switching circuit, a second terminal coupled to the terminal of the flyback switching circuit, and a third terminal coupled to the input of the flyback switching circuit.

### BRIEF DESCRIPTION OF THE DRAWINGS

FIG. 1 is a block diagram of an example system that includes a flyback converter with enhanced common mode transient immunity.

FIG. 2 is a schematic level diagram of an example of the system of FIG. 1.

FIG. 3 is a graph of example common-mode transient reduction in the flyback converter of FIG. 2

FIG. 4 is a block diagram of an example electric vehicle drive system that includes a flyback converter with enhanced common mode transient immunity.

### DETAILED DESCRIPTION

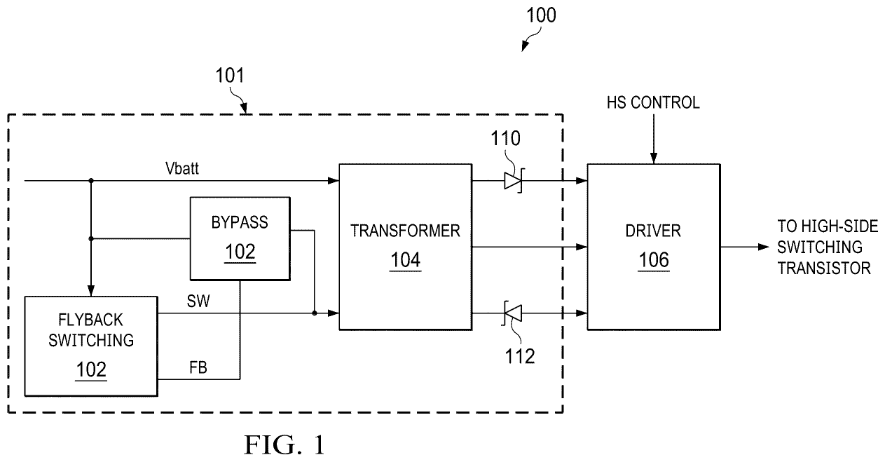

FIG. 1 is a block diagram of an example system 100. The system 100 includes a flyback converter 101 and a driver 106. The driver 106 is powered by the flyback converter 101. The driver 106 has an input coupled to a circuit (not shown) that provides a high-side control signal (HS CONTROL), and an output coupled to a high-side switching transistor. Such a high-side switching transistor may be part of an inverter or a switching converter in some example applications.

The flyback converter 101 provides the voltage for operating the driver 106. The flyback converter 101 includes a flyback switching circuit 102, a transformer 104, a bypass network 108, and rectifiers 110 and 112. The transformer 104 has a primary side coupled to the flyback switching circuit 102, and a secondary side coupled to the driver 106. The transformer 104 isolates circuitry on the primary side from circuitry on the secondary side. The rectifier 110 is coupled between a first secondary side terminal of the transformer 104 and the driver 106. The rectifier 112 is coupled between a second secondary side terminal of the transformer 104 and a second terminal of the driver 106. A center-tap terminal of the secondary side of the transformer 104 is also coupled to the driver 106. Some implementations of the flyback converter 101 may lack the rectifier 112, and the transformer 104 may lack a center tap. In such implementations, the second secondary side terminal of the transformer 104 may be coupled to the second terminal of the driver 106.

The flyback switching circuit 102 controls switching in the flyback converter 101. The flyback switching circuit 102 may be an LM5180 or LM5185 from TEXAS INSTRUMENTS INC., or a similar integrated or discrete flyback control circuit. The flyback switching circuit 102 has a power terminal, an output, and an input. The power terminal is coupled to a voltage source such as a battery or a power supply for receipt of a voltage (Vbatt) that powers the flyback switching circuit 102. The power terminal of the flyback switching circuit 102 is also coupled to a first primary side terminal of the transformer 104. The output of the flyback switching circuit 102 is coupled to a second primary side terminal of the transformer 104. The flyback switching circuit 102 provides a signal (SW) at the output of the flyback switching circuit 102. SW draws an alternating current through the primary side of the transformer 104, which induces a voltage on the secondary side of the transformer 104 to power the driver 106.

Switching on the secondary side of the transformer 104, for example, switching of the high-side transistor controlled by the driver 106 can produce transients (common mode transients) that propagate through parasitic capacitance of the transformer 104 to the primary side of the transformer 104. The flyback converter 101 is a primary-side regulated (PSR) flyback converter, in which a signal on the primary side of the transformer 104 is applied by the flyback switching circuit 102 to control regulation of the voltage provided to the driver 106. In some PSR flyback converters, the input of the flyback switching circuit 102, at which feedback signal (FB) is received (also referred to as the FB input) for controlling regulation is coupled to the output of the flyback switching circuit 102, at which SW is provided. In such implementations, transients originating on the secondary side of the transformer 104 can propagate onto FB and disrupt operation of the flyback converter (e.g., cause the voltage output by the flyback converter to fluctuate), which can reduce the efficiency of circuitry powered by the flyback converter 101. Reduced efficiency can cause overheating and damage to components of the circuitry powered by the flyback converter.

The bypass network 108 enhances the common mode transient immunity of the flyback converter 101. The bypass network 108 has a first terminal coupled to the output of the flyback switching circuit 102 (and the second terminal of the transformer 104), a second terminal coupled to the power terminal of the flyback switching circuit 102 (and the first terminal of the transformer 104), and a third terminal coupled to the input of the flyback switching circuit 102. The power terminal of the flyback switching circuit 102 to which the second terminal of the bypass network 108 is connected may be a voltage terminal (e.g., a terminal for receipt of Vbatt) or a ground terminal (e.g., a terminal for receipt of a ground voltage) in various examples of the flyback converter 101. Accordingly, the terminal of the flyback switching circuit 102 to which the second terminal of the bypass network 108 is coupled may be configured to receive a power supply voltage such as Vbatt or a ground voltage. The bypass network 108 conducts common mode transients present on SW to Vbatt, and significantly reduces the amplitude of the common mode transients present on FB. Accordingly, common mode transients generated on the secondary side of the transformer 104, are significantly less likely to degrade the operation of the flyback converter 101 than in flyback converters that lack the bypass network 108.

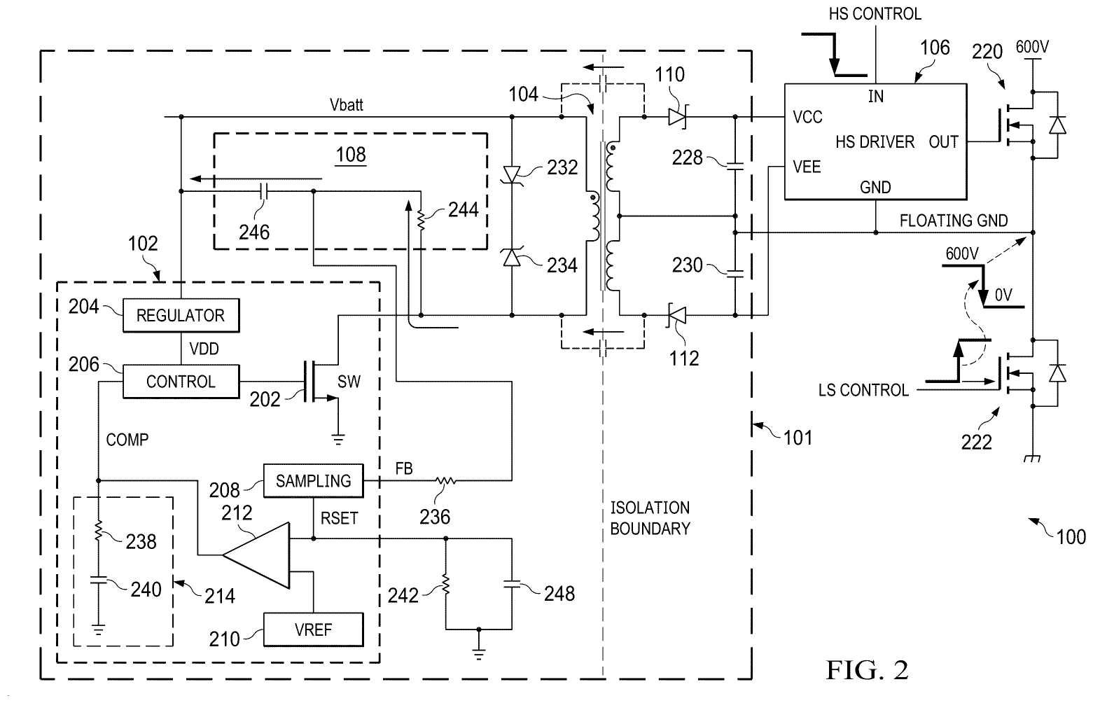

FIG. 2 is a schematic level diagram of the system 100. FIG. 2 shows the driver 106, and the flyback converter 101, which includes the flyback switching circuit 102, the transformer 104, and the bypass network 108. The flyback converter 101 also includes Zener diode 232, diode 234, and capacitors 228 and 230. Transistors 220 and 222 are shown as part of the system 100. The Zener diode 232 and the diode 234 are coupled in series across the terminals of the primary coil of the transformer 104 to limit the voltage across the primary coil. The rectifier 110 and the rectifier 112 coupled to the secondary coil of the transformer 104 are illustrated as Schottky diodes in FIG. 2. The capacitor 228 is coupled between the cathode of the rectifier 110 and the center tap of the secondary coil to filter the DC voltage provided at the cathode of the rectifier 110. The capacitor 230 is coupled between the anode of the rectifier 112 and the center tap of the secondary coil to filter the DC voltage provided at the anode of the rectifier 112. While the transformer 104 is illustrated as including two secondary winding, in various examples of the flyback converter 101, the transformer 104 may include one secondary winding, two secondary windings, or more than two secondary windings. For example, the transformer 104 may include more than two secondary windings to provide different voltage outputs for different driver circuits.

The transistor 220 has a first terminal (e.g., drain) coupled to a high-voltage source (not shown), a second terminal (e.g., source) coupled to the center tap of the secondary coil, and a control terminal (e.g., gate) coupled to the output of the driver 106. The transistor 222 has a first terminal (e.g., drain) coupled to the second terminal of the transistor 220, a second terminal (e.g., source) coupled to a reference terminal (e.g., ground), and control terminal (e.g., gate) coupled to control circuit (not shown). The control circuit may generate HS Control provided at the input of the driver 106, and LS Control provided at the control terminal of the transistor 222. The first terminal of the transistor 222 may transition between the high-voltage provided at the first terminal of the transistor 220 and zero volts provided at the second terminal of the transistor 222 as controlled by the signals HS Control and LS Control.

The flyback switching circuit 102 includes a transistor 202, a voltage regulator 204, a control circuit 206, a sampling circuit 208, a voltage reference circuit 210, an error amplifier 212, and a compensation network 214. The voltage regulator 204 has an input coupled to the power terminal of the flyback switching circuit 102. The voltage regulator 204 regulates Vbatt to produce a voltage VDD suitable for powering the various circuits of the flyback switching circuit 102. In some examples of the flyback switching circuit 102, an example of the voltage regulator 204 may derive VDD from a voltage other than Vbatt.

The control circuit 206 controls the transistor 202 to generate SW. The transistor 202 may be an n-channel field effect transistor (NFET). The transistor 202 has a first terminal (e.g., drain) coupled to the output of the flyback switching circuit 102, and a second terminal (e.g., source) coupled to a reference terminal (e.g., ground). A control terminal (e.g., gate) of the transistor 202 is coupled to an output of the control circuit 206. The control circuit 206 modulates the control signal provided to the control terminal of the transistor 202 based on an error signal (COMP) received from the error amplifier 212. An output of error amplifier 212 is coupled to an input of the control circuit 206. The compensation network 214 is also coupled to the output of the error amplifier 212. The compensation network 214 includes a resistor 238 and a capacitor 240 coupled in series between the output of the error amplifier 212 and a reference terminal (e.g., ground).

The error amplifier 212 has as first input (e.g., a non-inverting input) coupled to the voltage reference circuit 210, and a second input (e.g., inverting input) coupled to an output of the sampling circuit 208. The voltage reference circuit 210 generates a reference voltage that is relatively constant across process and temperature. The sampling circuit 208 samples FB received at the input of the flyback switching circuit 102. The sampling circuit 208 has an input coupled to the input of the flyback switching circuit 102 for receipt of FB. The sampling circuit 208 includes circuitry, such as a switched capacitor, to sample FB, and provide sampled FB at the output of the sampling circuit 208.

Switching of the transistor 220 and the transistor 222 on the secondary side of the transformer 104 can produce common-mode transients that propagate from the secondary side of the transformer 104 to the primary side of the transformer 104 via the parasitic capacitance of the transformer 104 (shown in FIG. 2). The bypass network 108 attenuates the common-mode transients present at the input of the flyback switching circuit 102 to prevent degradation of operation of the flyback converter 101. The bypass network 108 includes a resistor 244 and a capacitor 246. The capacitor 246 has a first terminal coupled to the power terminal of the flyback switching circuit 102, and a second terminal coupled to the second terminal of the primary coil of the transformer 104 via the resistor 244. In some examples of the flyback converter 101, the first terminal of the capacitor 246 may be coupled to a ground terminal, rather than to the power terminal of the flyback switching circuit 102. The resistor 244 has a first terminal coupled to the second terminal of the capacitor 246, and a second terminal coupled to the output of the flyback switching circuit 102 and the second terminal of the primary coil of the transformer 104.

Common-mode noise generated on the secondary side of the transformer 104 propagates to the primary side of the transformer 104 through the parasitic capacitance of the transformer 104, and the bypass network 108 provides a low impedance path that conducts the common-mode noise away from the input of the flyback switching circuit 102. The input of the flyback switching circuit 102 is coupled to the first terminal of the resistor 244 via a resistor 236. The resistor 236 has a first terminal coupled to the first terminal of the resistor 244, and a second terminal coupled to the input of the flyback switching circuit 102 for providing FB with attenuated common-mode noise to the flyback switching circuit 102. The resistor 236 may have a resistance of about 99 kilo-ohms (kohms) in some examples of the flyback converter 101. The resistor 244 may have a resistance of about 1 kohm in some examples of the flyback converter 101. The capacitor 246 may have capacitance of about 100 pico-Farads (pF) in some examples of the flyback converter 101. In some examples of the flyback converter 101, the resistor 244 has resistance in a range of from 10 Ohms to 10 kohms, not exceeding 1/10 of the resistance of the resistor 236. The capacitor 246 may have a capacitance in range of from 10 pF to 1000 pF in some examples of the flyback converter 101. The resistor 244 and the capacitor 246 may have other values of resistance and capacitance in some examples of the flyback converter 101.

The flyback switching circuit 102 also includes a reference current terminal coupled to the second terminal of the error amplifier 212 for providing a signal RSET that defines a reference current for FB. A resistor 242 is coupled between the reference current terminal of the flyback switching circuit 102 and the reference terminal (e.g., ground) to set RSET. Some implementations of the flyback converter 101 may include a capacitor 248 in parallel with the resistor 242. The capacitor 248 can further attenuate common-mode noise present at the second input of the error amplifier 212 to improve the common-mode transient immunity of the flyback converter 101. The capacitor 248 may have capacitance of up to about 4.7 pF in some examples of the flyback converter 101. The capacitance of the capacitor 248 may be less than about 33 pF in some examples of the flyback converter 101.

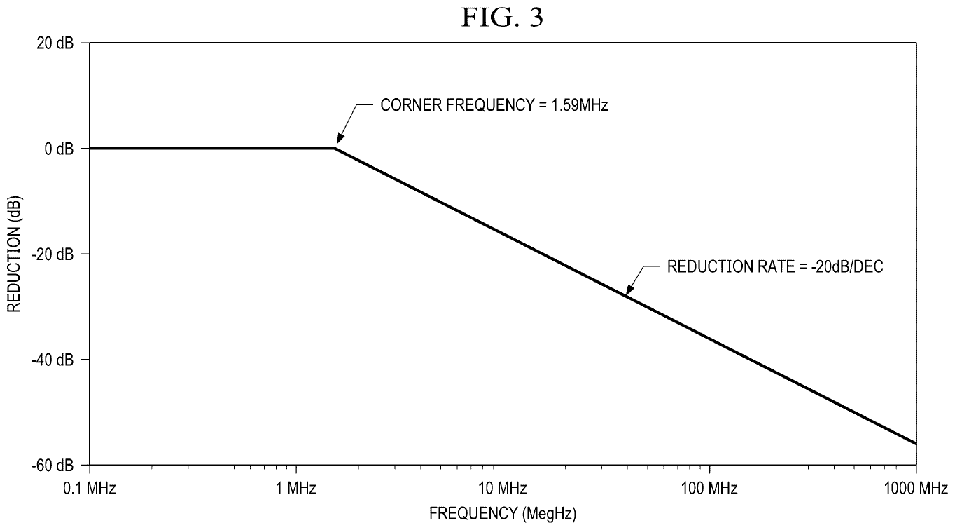

The bypass network 108 may reduce the common-mode noise on FB, at the input of the flyback switching circuit 102, at a rate of −20 decibels (dB) per decade starting from the corner frequency of the bypass network 108 as determined by the resistor 244 and capacitor 246. FIG. 3 shows an example of common-mode noise reduction in the flyback switching circuit 102 with the resistor 244 having a resistance of about 1 kohm and the capacitor 246 having a capacitance of about 100 pF. In FIG. 3, the x-axis is frequency in MHz and the y-axis is noise amplitude reduction in dB. FIG. 3 shows noise reduction ranging from 0 dB at 1 MHz to almost 60 dB at 1000 MHz. Table 1 below lists examples of common mode noise reductions at different frequencies in the example of FIG. 3. Common-mode noise at 10 megahertz (MHz) is reduced by 84.2%. Common-mode noise at 20 MHz is reduced by 92.2%. Common-mode noise at 100 MHz is reduced by about 98.4%. Use of the capacitor 248 in conjunction with the bypass network 108 can further increase the common-mode reduction of the flyback converter 101.

TABLE 1

| | Common Mode | | Amount of CM |
|---|---|---|---|
| Frequency | Noise Reduction | Amount of CM | Noise Passing to |
| (MHz) | (in dB) | Noise Reduced | FB input |
| 10 | −16 | 84.2% | 15.8% |
| 20 | −22 | 92.2% | 7.8% |
| 100 | −36 | 98.4% | 1.6% |

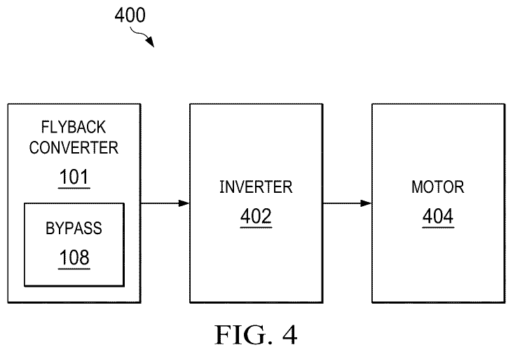

FIG. 4 is a block diagram of an example electric vehicle drive system 400. The electric vehicle drive system 400 includes an inverter circuit 402, an electric motor 404, and an example of the flyback converter 101. The electric motor 404 may be mechanically coupled to the wheels or other drive structure of a vehicle, where operation of the electric motor 404 provides vehicle propulsion. The electric motor 404 is coupled to the inverter circuit 402 for receipt of drive signals generated by the inverter circuit 402 that actuate the electric motor 404. The inverter circuit 402 is coupled to the flyback converter 101. The inverter circuit 402 may include the driver 106 and/or other circuitry powered by the flyback converter 101. Operation of the inverter circuit 402 produces common-mode transients that can propagate to the flyback converter 101 and degrade the operation thereof, which can reduce the efficiency of the inverter circuit 402. For example, an implementation of the inverter circuit 402 using silicon carbide transistors with a slew rate of 100 volts per nanosecond can produce common-mode noise with frequencies above 100 MHz. The flyback converter 101 includes the bypass network 108, which significantly enhances the common-mode immunity of the flyback converter 101 as shown in FIG. 3 and Table 1, and improves the efficiency of the inverter circuit 402.

The flyback converter 101 may also be used in various systems that include a flyback converter susceptible to common-mode noise generated by circuitry powered by the flyback converter, such as electric vehicle charging circuitry, industrial power inverters, and heating, ventilation, and air conditioning systems.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors, or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control input and its current terminals. In the context of a FET, the control input is the gate, and the current terminals are the drain and source. In the context of a BJT, the control input is the base, and the current terminals are the collector and emitter.

References herein to a FET being “ON” or “enabled” means that the conduction channel of the FET is present and drain current may flow through the FET. References herein to a FET being “OFF” or “disabled” means that the conduction channel is not present so drain current does not flow through the FET. An “OFF” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

Modifications are possible in the described embodiments, and other embodiments are possible, within the scope of the claims.

What is claimed is:

1. A circuit comprising:
a flyback switching circuit having a terminal configured to receive a power supply voltage, an output, and an input;
a transformer including a coil having a first terminal coupled to the terminal of the flyback switching circuit, and a second terminal coupled to the output of the flyback switching circuit; and
a bypass network having a first terminal coupled to the output of the flyback switching circuit, a second terminal coupled to the terminal of the flyback switching circuit, and a third terminal coupled to the input of the flyback switching circuit.

2. The circuit of claim 1, wherein the bypass network includes a capacitor having a first terminal coupled to the terminal of the flyback switching circuit, and a second terminal coupled to the output of the flyback switching circuit.

3. The circuit of claim 2, wherein the bypass network includes a resistor having a first terminal coupled to the second terminal of the capacitor, and a second terminal coupled to the output of the flyback switching circuit.

4. The circuit of claim 3, wherein the first terminal of the resistor is coupled to the input of the flyback switching circuit.

5. The circuit of claim 3, wherein the resistor has a resistance of about 1 kilo-ohm and the capacitor has a capacitance of about 100 pico-Farads.

6. The circuit of claim 3, wherein:
the resistor is a first resistor; and
the circuit includes a second resistor having a first terminal coupled to the first terminal of the first resistor, and a second terminal coupled to the input of the flyback switching circuit.

7. The circuit of claim 6, wherein:
the flyback switching circuit has a second terminal; and
the flyback switching circuit includes an error amplifier having a first input coupled to the input of the flyback switching circuit and the second terminal of the flyback switching circuit; and
the circuit includes:
a resistor having a first terminal coupled to the second terminal of the flyback switching circuit, and a second terminal coupled to a reference terminal; and
a capacitor having a first terminal coupled to the second terminal of the flyback switching circuit, and a second terminal coupled to a reference terminal.

8. A circuit comprising:
a flyback switching circuit having a terminal configured to receive a power supply voltage, an output, and an input configured to receive a feedback signal;
a transformer including a primary coil and a secondary coil, the primary coil having a first terminal coupled to the terminal of the flyback switching circuit, and a second terminal coupled to the output of the flyback switching circuit; and
a bypass network having a first terminal coupled to the output of the flyback switching circuit, a second terminal coupled to the terminal of the flyback switching circuit, and a third terminal coupled to the input of the flyback switching circuit, the bypass network configured to attenuate, at the input of the flyback switching circuit, transients passing from the secondary coil to the primary coil.

9. The circuit of claim 8, wherein the bypass network includes a capacitor and a resistor coupled in series between output of the flyback switching circuit and the terminal of the flyback switching circuit.

10. The circuit of claim 9, wherein the resistor and the capacitor are configured to conduct the transients to the terminal of the flyback switching circuit.

11. The circuit of claim 9, wherein the capacitor has a capacitance of about 100 pico-Farads, and the resistor has a resistance of about 1 kilo-ohm.

12. The circuit of claim 9, wherein:
the resistor has a first terminal coupled to the output of the flyback switching circuit, and a second terminal; and
the capacitor has a first terminal coupled to the second terminal of the resistor, and a second terminal coupled to the terminal of the flyback switching circuit.

13. The circuit of claim 12, wherein:
the resistor is a first resistor; and
the circuit includes a second resistor having a first terminal coupled to the first terminal of the capacitor, and a second terminal coupled to the input of the flyback switching circuit.

14. The circuit of claim 13, wherein:
the flyback switching circuit has a second terminal; and
the flyback switching circuit includes an error amplifier having a first input coupled to the input of the flyback switching circuit and the second terminal of the flyback switching circuit; and
the circuit includes:
a resistor having a first terminal coupled to the second terminal of the flyback switching circuit, and a second terminal coupled to a reference terminal; and
a capacitor having a first terminal coupled to the second terminal of the flyback switching circuit, and a second terminal coupled to the reference terminal.

15. A vehicle drive system comprising:
an electric motor;
an inverter circuit having an output coupled to the electric motor, and an input; and
a flyback converter including:
a flyback switching circuit having a terminal configured to receive a power supply voltage, an output, and an input;
a transformer including:
a primary coil having a first terminal coupled to the terminal of the flyback switching circuit, and a second terminal coupled to the output of the flyback switching circuit; and
a secondary coil coupled to the input of the inverter circuit; and
a bypass network having a first terminal coupled to the output of the flyback switching circuit, a second terminal coupled to the terminal of the flyback switching circuit, and a third terminal coupled to the input of the flyback switching circuit.

16. The vehicle drive system of claim 15, wherein the bypass network includes a capacitor and a resistor coupled in series between output of the flyback switching circuit and the terminal of the flyback switching circuit.

17. The vehicle drive system of claim 16, wherein:
the resistor has a first terminal coupled to the output of the flyback switching circuit, and a second terminal; and
the capacitor has a first terminal coupled to the second terminal of the resistor, and a second terminal coupled to the terminal of the flyback switching circuit.

18. The vehicle drive system of claim 16, wherein:
the resistor is a first resistor; and
the circuit includes a second resistor having a first terminal coupled to the first terminal of the capacitor, and a second terminal coupled to the input of the flyback switching circuit.

19. The vehicle drive system of claim 18, wherein:
the flyback switching circuit has a second terminal; and
the flyback switching circuit includes an error amplifier having a first input coupled to the input of the flyback switching circuit and the second terminal of the flyback switching circuit; and
the circuit includes:
a resistor having a first terminal coupled to the second terminal of the flyback switching circuit, and a second terminal coupled to a reference terminal; and
a capacitor having a first terminal coupled to the second terminal of the flyback switching circuit, and a second terminal coupled to the reference terminal.

20. The vehicle drive system of claim 15, wherein the bypass network is configured to attenuate, at the input of the flyback switching circuit, transients passing from the secondary coil to the primary coil.
